(19) United States
(12) Patent Application Publication
(10) Pub. No.: US 2005/0033763 A1
(43) Pub. Date: Feb. 10, 2005

(54) System and method for providing a non-specific graphical user interface framework

(76) Inventors: Shyhshiun Chen, Naperville, IL (US); Darrell Kooy, Aurora, IL (US)

Correspondence Address: FISH & RICHARDSON P.C., 5000 BANK ONE CENTER, 1717 MAIN STREET, DALLAS, TX, 75201, US

(21) Appl. No.: 10/888,119

(22) Filed: Jul. 9, 2004

Related U.S. Application Data
(60) Provisional application No. 60/486,377, filed on Jul. 11, 2003.

(51) Int. Cl. G06F 17/00; G06F 9/44; G06F 17/30; G06F 9/45

(52) U.S. Cl. 707/102; 717/109; 717/113; 717/141; 717/169; 707/205; 707/4; 707/2

(57) ABSTRACT

A method for providing a graphical user interface (GUI) framework includes loading one or more GUI plug-ins based on a request from a client, each GUI plug-in associated with one or more windowed applications. A non-specific GUI framework is generated based, at least in part, on the loaded GUI plug-ins. Next, at least a portion of the GUI framework is presented to the client.

### RELATED APPLICATION

This application claims the priority under 35 U.S.C. §119 of provisional application Ser. No. 60/486,377 filed Jul. 11, 2003.

### TECHNICAL FIELD

This disclosure relates generally to the field of computer systems, and more particularly to a system and method for providing a non-specific graphical user interface framework.

### BACKGROUND

A graphical user interface (GUI) provides a front-end of a software application to a client. Conventional windowed applications present a single format of a user interface to the client and normally are only compatible with certain Windows-based operating systems. These traditional user interfaces must normally be redesigned and often manually recoded to provide a different software front-end or to be compatible with other operating systems such as Unix, Linux, and others.

### SUMMARY

This disclosure provides a system and method for providing a graphical user interface. In one embodiment, the method for providing a graphical user interface (GUI) framework includes loading one or more GUI plug-ins based on a request from a client, each GUI plug-in associated with one or more windowed applications. A non-specific GUI framework is generated based, at least in part, on the loaded GUI plug-ins. Next, at least a portion of the GUI framework is presented to the client. The details of one or more embodiments of the disclosure are set forth in the accompanying drawings and the description below. Particular features, objects, and advantages of the disclosure will be apparent from the description and drawings and from the claims.

### BRIEF DESCRIPTION OF DRAWINGS

FIG. 1 is an exemplary block diagram illustrating an example system for providing a generic graphical user interface framework according to one embodiment of this disclosure;

FIG. 2 is an exemplary diagram illustrating an example graphical user interface framework according to one embodiment of this disclosure; and

FIG. 3 is an exemplary flow diagram illustrating an example method for providing a generic graphical user interface framework according to one embodiment of this disclosure.

### DETAILED DESCRIPTION

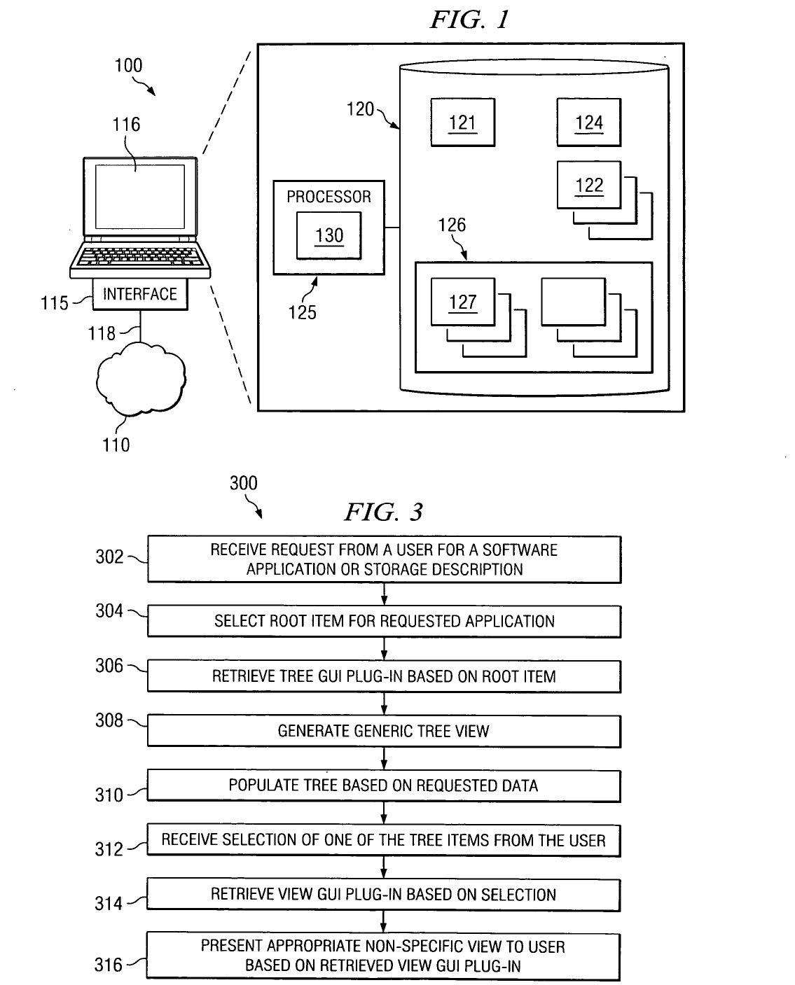

FIG. 1 illustrates a computing system 100 for providing a generic or non-specific graphical user interface framework 126. In general, the present disclosure contemplates any system 100 that presents at least a portion of a device independent GUI framework 126 including a tree view and a user-defined view. Accordingly, computer 100 may comprise a portion of an information management system operable to dynamically load one or more GUI plug-ins 127 from a registry 121 based on a request from a user of computer 100. For example, system 100 may automatically provide an explorer-type interface, including an extensible pop-up menu for tree items, through the generic GUI framework 126 in response to a request from a user. The term “automatically,” as used herein, generally means that the appropriate processing is substantially performed by at least part of system 100. It should be understood that “automatically” further contemplates any suitable user interaction with system 100 without departing from the scope of this disclosure. The term “dynamically,” as used herein, generally means that the appropriate processing is determined at run-time based on one or more variables. As used herein, the term “Windows-based” includes any MICROSOFT WINDOWS, WINDOWS-compatible, WINDOWS-based, or other windowed software application, device, or operating system 124.

Computer system 100 includes memory 120 and processor 125. The present disclosure includes presentation engine 130 and GUI plug-ins 132 that may be stored in memory 120 and may be executed or processed by processor 125. FIG. 1 only provides one example of a computer that may be used with the disclosure. The present disclosure contemplates computers other than general purpose computers as well as computers without conventional operating systems. As used in this document, the term “computer” is intended to encompass a personal computer, workstation, network computer, or any other suitable processing device. Further, “computer” and “user of computer” may be used interchangeably without departing from the scope of this disclosure. While described as executing Microsoft Windows, computer system 100 may execute any operating system including UNIX, Linux, or any other operating system as appropriate.

Computer 100 may also include an interface 115 for communicating with other computer systems over network 110 such as, for example, in a client-server or other distributed system. In certain embodiments, computer 100 receives GUI plug-ins 132 from network 110 for storage in memory 120. Network 110 facilitates wireless or wireline communication between computer system 100 and any other computer. Network 110 may communicate, for example, Internet Protocol (IP) packets, Frame Relay frames, Asynchronous Transfer Mode (ATM) cells, voice, video, data, and other suitable information between network addresses. Network 110 may include one or more local area networks (LANs), radio access networks (RANs), metropolitan area networks (MANs), wide area networks (WANs), all or a portion of the global computer network known as the Internet, and/or any other communication system or systems at one or more locations. Generally, interface 115 comprises logic encoded in software and/or hardware in a suitable combination and operable to communicate with network 110 via link 118. More specifically, interface 115 may comprise software supporting one or more communications protocols associated with link 118 and communications network 110 hardware operable to communicate physical signals.

GUI 116 comprises a graphical user interface operable to allow the user of computer 100 to interface in order to manipulate or view data, processes, or files through GUI framework 126. Generally, GUI 116 provides the user of computer 100 with an efficient and user-friendly presentation of data provided by system 100, such as trees and extensible pop-up menus. GUI 116 may comprise a plurality of displays having interactive fields, pull-down lists, and buttons operated by the user. It should be understood that the term graphical user interface may be used in the singular or in the plural to describe one or more graphical user interfaces and each of the displays of a particular graphical user interface. Further, GUI 116 contemplates any graphical user interface, such as a generic web browser, that processes information in system 100 and efficiently presents the information to the user. Any computer can accept data via the web browser (e.g., Microsoft Internet Explorer or Netscape Navigator) and return the appropriate HTML, Java, or eXtensible Markup Language (XML) responses.

Memory 120 may include any memory or database module and may take the form of volatile or non-volatile memory including, without limitation, magnetic media, optical media, random access memory (RAM), read-only memory (ROM), removable media, or any other suitable local or remote memory or storage component. In the illustrated embodiment, memory 120 includes a registry 121 of a Windows-based operating system, one or more software applications 122 operable to run on operating system 124, resource scripts files 123, and GUI plug-ins 127. Memory 120 may include any other data without departing from the scope of this disclosure.

Registry 121 is a hierarchical listing in Windows-based operating systems, typically used to store information to configure computer 100 for one or more users, software applications 122, and various hardware devices. Registry 121 includes information that is referenced by illustrated Windows-based operating system 124 to adequately execute various processes such as, for example, software applications 122 installed on computer 100, the respective types of files created by each application 122, and property sheet settings for folders and icons. Moreover, registry 121 often includes registry entries of one or more GUI plug-ins 126 This information is often contained in registry entries that are logically organized into a hierarchy. Computer 100 also includes one or more software applications with resource scripts or any logical description of data storage jointly illustrated at 122), such as LDAP directories, Windows or Unix directories, database hierarchy, and others. For example, software application 122 may comprise any type of software (operable to run in any suitable environment) that includes a graphical front-end that is presented to the user based on the associated resource script file. In one embodiment, software application 122 comprises any Windowed module, library, directory, file, or other data operable to translated, converted, or mapped to a nonspecific format. It will be understood that while FIG. 1 illustrates software application 122 and its associated resource script being stored in memory 120, either may be located in a distributed system and be remotely executed, accessed, or requested over network 110.

Computer 100 also includes a generic GUI framework 126 for presenting a plurality of GUI plug-ins 127, normally registered in registry 121 for efficient processing. GUI plug-in 127 could include any hardware, software, firmware, or combination thereof operable to present the graphical resources or Windows control associated with one or more Windowed software applications through generic or nonspecific GUI framework 126. As used herein, “nonspecific” means that the user interface is operable to be presented using any suitable web browser and/or to be executed in various Windows-based and non-Windows-based operating systems. In one embodiment, GUI plug-in 127 displays a portion of an explorer-type framework 126 with a tree left view or a client panel or HTML right view. For example, GUI plug-in 127 may comprise a script, file, Dynamic Linked Library (DLL), “jar” file, or any other suitable module written in any appropriate computer language such as, for example, C, C++, Java, J#, Perl, Visual Basic, and others. It will be understood that while GUI plug-in 127 is illustrated as a single multi-tasked module, the features and functionality performed by this plug-in may be performed by multiple modules. This disclosure contemplates that GUI plug-in 127 may be generated by system 100, provided by a software or other third-party vendor, manually coded by a user, or otherwise communicated to system 100, so long as GUI plug-in 127 is operable to be loaded by generic framework 126 and executed on a plurality of operating systems.

In one embodiment, GUI plug-in 127 comprises Java source code and provides an explorer-type interface. In this embodiment, Java property pages may be created based on Win32 Dialog boxes in a resource script file and stored in GUI plug-in 127. GUI plug-in 127 often includes tree nodes or items for a left-hand side of the explorer interface. Also, GUI plug-in 127 may include menus for the right-click of a mouse on a tree node by subdlassing a menu class. Computer 100 may further create toolbars for the right click of the mouse on the tree node by subclassing a toolbar class. GUI plug-in 127 may further present a generic property sheet. GUI plug-in 127 may also comprise at least one property page for each dialog box. Another possible graphical item based on a construct from the resource script is an Inclusion Page Dialog. Each Inclusion Page Dialog shows relations between objects such as, for example, users in a group or groups that a user is in. GUI plug-in 127 may present an HTML viewer in framework 126 to the user of computer 100 via GUI 116. Accordingly, GUI plug-in 127 may also comprise an HTML viewer or user-defined viewer object.

Processor 125 executes instructions and manipulates data to perform the operations of computer 100, such as presentation engine 130. Although FIG. 1 illustrates a single processor 125 in computer 100, multiple processors 125 may be used according to particular needs, and reference to processor 125 is meant to include multiple processors 125 where applicable. In the embodiment illustrated, computer 100 includes presentation engine 130 that integrates previously generated GUI plug-ins 127 into a non-specific GUI framework 126 for use by a plurality of disparate computers, operating systems, and users. Presentation engine 130 could include any hardware, software, firmware, or combination thereof operable to process GUI plug-ins 127 and present generic GUI framework 126 to the user. Presentation engine 130 may be written in any appropriate computer language such as, for example, C, C++, Java, Perl, 3 GL or 4 GL custom language and others. It will be understood that while presentation engine 130 is illustrated as a single multi-tasked module, the features and functionality performed by this engine may be performed by multiple modules such as, for example, a registration module, a web-enabled module and a generation module.

In one aspect of operation, a user requests, indicates, or otherwise selects a particular file, directory, or other data for presentation using GUI framework 126. Presentation engine 130 loads the appropriate information into the tree view of GUI framework 126 using one of the GUI plug-ins 127. Upon user selection or request of one of the nodes in the tree, presentation engine 130 selects a second one of the GUI plug-ins 127 for loading into GUI framework 126. This second GUI-plug 127 presents a user-defined view of the selected node. Either view may present or allow any action or information in a nonspecific format without departing from the scope of this disclosure.

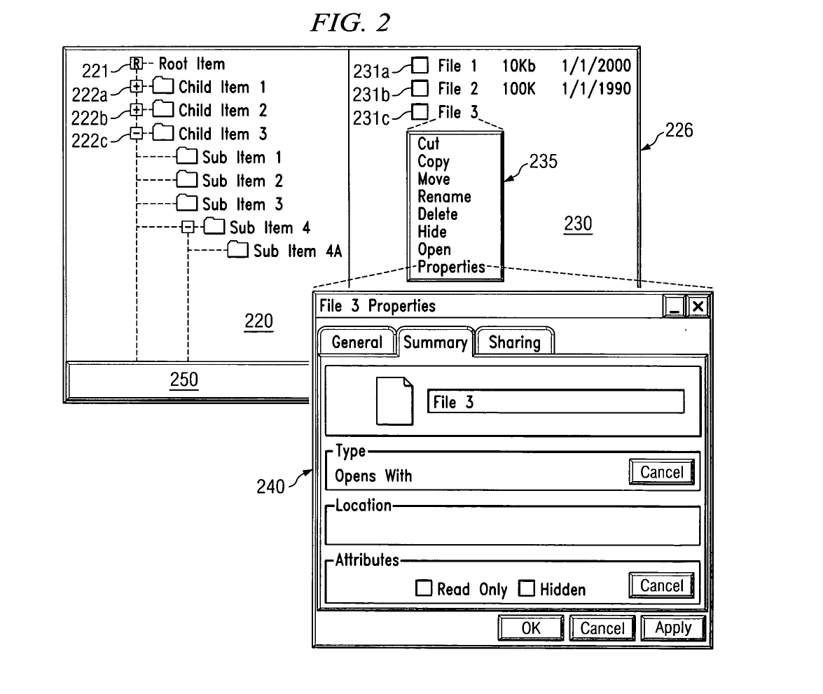

FIG. 2 is an exemplary diagram illustrating an example graphical user interface framework 226, or one example of GUI framework 126, according to one embodiment of this disclosure. Often, graphical user interface framework 226 is presented to client 102 using GUI 116; said another way, graphical user interface framework 226 may be considered interchangeable with GUI 116 as appropriate. In general, graphical user interface framework 226 presents a nonspecific view of data formatted by one or more GUI plug-ins 127.

FIG. 2 illustrates an example graphical user interface framework 226. At a high level, example graphical user interface framework 226 includes tree view 220, HTML or user-defined view, and status bar 250. Tree view 220 presents root item 221 and one or more child items 222. Generally, tree view 220 allows the user to select different nodes in a logical tree based on selected directories, files, or other storage information. User-defined view 230 presents the appropriate GUI-plug 127 and the component selection or display elements 235. Illustrated user-defined view 230 includes three files 231 stored or referenced in the selected child-item 222. Status bar 250 may present any high-level, summary, or status information involving the selected item.

Based at least partially on the user selection of a tree node, GUI framework 226 retrieves the appropriate generic GUI plug-in 127. For example, if the user selects a different node from the one illustrated, presentation engine 130 may automatically retrieve a different plug-in and present different information, in the same or different format, in graphical user interface framework 226. GUI framework 226 processes the GUI plug-in 127 and presents non-specific, extensible file property box, dialog box, or pop-up menu 235 to the user. Put another way, this property box was defined, represented, customized, generated, or coded in GUI plug-in 127 and is operable to be presented on computers using disparate operating systems, hardware, or computer languages. As illustrated, property box 235 includes a child dialog box 240 upon selected by the user. It will be understood that exemplary GUI framework 226 is for illustration purposes only and may include none, some, or all of the illustrated presentation elements as well as additional presentation elements not shown.

FIG. 3 is an exemplary flow diagram illustrating an example method 300 for providing a graphical user interface framework 126 according to one embodiment of this disclosure. Method 300 is presently described with respect to system 100. But method 300 could also be used by any other suitable system. Although FIG. 3 illustrates one example of a method 300 for providing graphical user interface framework 126, various changes may be made to FIG. 3. For example, presentation engine 130 may automatically select software application or storage description 122 upon initialization or upon boot-up of computer 100.

Method 300 begin at 302, where presentation engine 130 receives a request from a user for a presentation of a software application or storage description 122. This request may be dynamically determined based on certain criteria, be a manual selection or mouse click, or be any other suitable selection. At step 304, presentation engine 130 selects the root item in the selected resource script or storage description 122. For example, the requested description 122 may comprise a UNIX directory and the selected root item is the highest level logical element in the directory. Based on this selection, presentation engine 130 retrieves first GUI plug-in 127 at step 306 and generates a generic tree view at step 308. Presentation engine 130 then populates tree view 220 with the data from the requested item 122 as formatted by GUI plug-in 127 at step 310. Typically, first GUI plug-in 127 is operable to display customized information in a tree format in tree view 220 through generated GUI framework 126. At this point, user-defined view 230 may be blank, filled with default information, or present any other data or graphical elements. Upon selection of one of the nodes presented in tree view 220 at step 312, presentation engine 130 retrieves second GUI-plug-in 127 to generate the user-defined view 230 at step 314. At step 316, presentation engine presents the nonspecific view 230 of the selected data item to the requesting user. Next, while not illustrated, GUI framework 126 may display a dialog box 235 to the user, thereby providing possible actions and customized information on one of the items in the user-defined view 230.

The preceding flowchart focuses on the operation of example computer system 100 and presentation engine 130 described in FIG. 1, as this diagram illustrates functional elements that provide for the preceding techniques. However, as noted, computer 100 contemplates using any suitable combination and arrangement of functional elements for providing these operations, and these techniques can be combined with other techniques as appropriate. Further, various changes may be made to the following flowcharts without departing from the scope of this disclosure. Thus, many of the steps in this flowchart may take place simultaneously and/or in different orders than as shown. Moreover, computer 100 may use alternative or additional methods with additional steps, fewer steps, and/or different steps, so long as the methods remain appropriate.

While this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method for providing a non-specific graphical user interface (GUI) framework, comprising:
loading one or more GUI plug-ins based on a request from a client, each GUI plug-in associated with one or more windowed applications;
generating a non-specific GUI framework based, at least in part, on the loaded GUI plug-ins; and
presenting at least a portion of the GUI framework to the client.

2. The method of claim 1, the GUI framework comprising a tree view and a user-defined view.

3. The method of claim 2, the GUI framework further comprising an extensible toolbar, a message window, and a status bar.

4. The method of claim 1 further comprising selecting the GUI plug-ins based on a registry entry in a Windows-based operating system.

5. The method of claim 2 further comprising:
determining a root item for each windowed application; and
generating the tree view based on the root item, the tree view comprising a plurality of tree items organized in a logical tree hierarchy.

6. The method of claim 2, the user-defined view comprising one of a user-defined property page, a user-defined tabbed dialog, and an HTML viewer.

7. The method of claim 2, wherein loading one or more GUI plug-ins based on the selected windowed application comprises:
loading at least one GUI plug-in for the tree view; and
loading at least one GUI plug-in for the user-defined view.

8. The method of claim 1 further comprising inserting at least a portion of the logic from at least one of the windowed applications into the generated GUI framework.

9. Software for providing a non-specific graphical user interface (GUI) framework, operable to:
load one or more GUI plug-ins based on a request from a client, each GUI plug-in associated with one or more windowed applications;
generate a non-specific GUI framework based, at least in part, on the loaded GUI plug-ins; and
present at least a portion of the GUI framework to the client.

10. The software of claim 9, the GUI framework comprising a tree view and a user-defined view.

11. The software of claim 10, the GUI framework further comprising an extensible toolbar, a message window, and a status bar.

12. The software of claim 9 further operable to select the GUI plug-ins based on a registry entry in a Windows-based operating system.

13. The software of claim 10 further operable to:
determine a root item for each windowed application; and
generate the tree view based on the root item, the tree view comprising a plurality of tree items organized in a logical tree hierarchy.

14. The software of claim 10, the user-defined view comprising one of a user-defined property page, a user-defined tabbed dialog, and an HTML viewer.

15. The software of claim 10, wherein the software operable to load one or more GUI plug-ins based on the selected Windowed application comprises software operable to:
load at least one GUI plug-in for the tree view; and
load at least one GUI plug-in for the user-defined view.

16. The software of claim 9 further operable to insert at least a portion of the logic from at least one of the windowed applications into the generated GUI framework.

17. A system for providing a non-specific graphical user interface (GUI) framework, comprising:
memory for storing a plurality of GUI plug-ins, each GUI plug-in associated with one or more windowed applications
one or more processors operable to:
load one or more of the GUI plug-ins based on a request from a client;
automatically generate a generic GUI framework based, at least in part, on the loaded GUI plug-ins; and
present at least a portion of the GUI framework to the client.

18. The system of claim 17, the GUI framework comprising a tree view and a user-defined view.

19. The system of claim 18, the GUI framework further comprising an extensible toolbar, a message window, and a status bar.

20. The system of claim 17, the one or more processors further operable to select the GUI plug-ins based on a registry entry in a Windows-based operating system.

21. The system of claim 18, the one or more processors further operable to:
determine a root item for each windowed application; and
generate the tree view based on the root item, the tree view comprising a plurality of tree items organized in a logical tree hierarchy.

22. The system of claim 18, the user-defined view comprising one of a user-defined property page, a user-defined tabbed dialog, and an HTML viewer.

23. The system of claim 18, wherein the one or more processors operable to load one or more GUI plug-ins based on the selected windowed application comprises one or more processors operable to:
load at least one GUI plug-in for the tree view; and
load at least one GUI plug-in for the user-defined view.

24. The system of claim 17, the one or more processors further operable to insert at least a portion of the logic from at least one of the windowed applications into the generated GUI framework.

25. A system, comprising:
means for loading one or more GUI plug-ins based on a request from a client, each GUI plug-in associated with one or more windowed applications;
means for generating a non-specific GUI framework based, at least in part, on the loaded GUI plug-ins; and
means for presenting at least a portion of the GUI framework to the client.
